(19) United States
(12) Patent Application Publication
(10) Pub. No.: US 2014/0231105 A1
(43) Pub. Date: Aug. 21, 2014

(54) Spray Head

(71) Applicant: Marioff Corporation OY, Vantaa (FI)

(72) Inventors: Jarmo Helasuo, Espoo (FI); Jarkko Malinen, Lahti (FI)

(21) Appl. No.: 14/110,290

(22) PCT Filed: Apr. 4, 2012
(86) PCT No.: PCT/FI12/50343

§ 371 Date: Apr. 17, 2014

(30) Foreign Application Priority Data
Apr. 8, 2011 (FI) 20115336

(51) Int. Cl. A62C 3/07; B05B 12/12

(52) U.S. Cl. CPC A62C 3/07; B05B 12/12
USPC 169/46; 169/19

(57) ABSTRACT

A spray head (1), comprising a fastening body (2), a spray head body (3) with at least one nozzle (4) and a thermally activated triggering device (5), said spray head body (3) being arranged into fastening body (2), in its cylinder space (21) to be movable between two positions, the first position, in which spray head is in the inactive state, and the second position, in which the spray head body is extended out, said spray head body (3) being arranged to be movable through the effect of pressurized medium in relation to fastening body (2) from the first position to the second position. A retaining arrangement (18, 19, 20) has been arranged between spray head body (3) and fastening body (2), adapted to keep spray head body (3) in the first position, until the pressure of the medium exceeds a preset value.

### BACKGROUND OF THE INVENTION

The invention relates to the spray head according to the introduction of claim 1.

The invention also relates to the use of the spray head.

One such spray head intended particularly for fire extinguishing is known for example from publication EP 1150747. The dome part that protects the nozzles of the spray head and the triggering device is released with a device that can be moved in relation to the holder body. The publication presents some different alternatives for releasing the dome part and for getting the spray head into a ready-position. A spray head is also known from publication WO 2007/082988 A1, in which the spray head body is formed to be movable and the spray head body exerts a force on a protection device that releases the protection device. Further known from the publication WO 2011/001018A1 is a spray head intended especially for vehicles, in which the fastening body of a triggering device has been made movable and exerts a force on a protection device, which releases the protection device. Among the drawbacks in the prior art solutions is the separate protection device, that falls off as the spray head becomes activated and in an unwanted event, while falling, may cause harm by striking people, animals or equipment. A spray head that contains parts that become detached, is also exposed to the effects of external forces and vandalism.

The objective of the invention is to achieve a spray head that makes it possible to avoid disadvantages in the prior art. For spray heads of extinguishing systems located in public premises it is particularly necessary to achieve a spray head solution, that will withstand the forces applied to it, as well as possible attempts at vandalism. In addition, spray heads located especially in vehicles or means of transportation, such as railroad cars, are exposed to various forces, such as vibration, impacts, which a spray head must withstand as well as possible. A further objective is to provide a spray head, from which no loose parts will become separated, as the spray head moves from the inactive state to the ready-state.

### BRIEF DESCRIPTION OF THE INVENTION

A spray head according to the invention is characterized by what is stated in claim 1.

A spray head according to the invention is further characterized by what is stated in claims 2-18.

The invention also concerns the use of a spray head according to any of claims 1-18 in a fire extinguishing system of a vehicle or means of transportation, such as a train.

A solution according to the invention has numerous significant advantages. By arranging the spray head to be movable and by providing a retainer arrangement in connection with it, an effective solution is achieved to problems in the prior art. With an arrangement according to the invention, an effective protection of the spray head is achieved against external forces. By using the retaining arrangement, an unwanted inadvertent shift of the spray body of the spray head from the first position toward the second position is avoided. Through the use of extinguishing medium to move the spray head, an advantageous solution is provided for the shifting of the spray head from the inactive to the ready position. No separate protective dome is needed in the solution according to the invention, and no loose parts will become separated from it when moving into ready-position. Construction of a spray head according to the invention is also advantageous from the technical standpoint of manufacturing. A spray head according to the invention is very suitable to be placed in circumstances, in which it is necessary to protect the spray head from things like environmental conditions and externally applied forces. The spray head is suitable, for example, for use in public premises, vehicles, or means of transportation, such as railroad cars. The solution is very suitable specifically to fire extinguishing applications, and more particularly to applications in which mist with liquid content is used as an extinguishing medium. A retaining arrangement can be formed using a retaining element or a bonding agent, such as glue or soldering material. The position of the collar section in relation to the fastening body is adjustable, whereby the spray head can be adapted to numerous different applications. Correspondingly, the position of the spray head body in relation to the fastening body may be adjustable at least in the first position, which improves the suitability of the spray head to different applications. By arranging several location points, such as grooves, for the retaining elements, an advantageous arrangement is achieved for the adjustment of the mutual position between the spray head body and the fastening body, at least in the first position.

### BRIEF DESCRIPTION OF THE DRAWINGS

The following is a more detailed description of the invention, by way of an example and referring to the accompanying drawing, in which

FIG. 1 illustrates a spray head according to the invention as a cross section in the first position. i.e. in the inactive position,

FIG. 2 illustrates a spray head according to the invention as a cross section in the second position. i.e. in the ready position, and

FIG. 3 illustrates a spray head according to the invention in the second position. i.e. in the ready position.

### DETAILED DESCRIPTION OF THE INVENTION

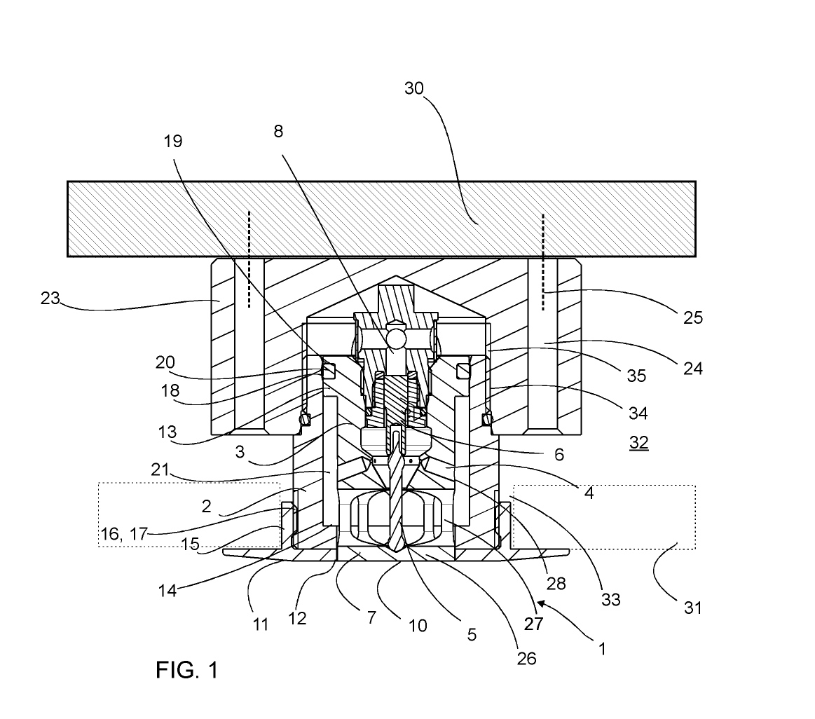

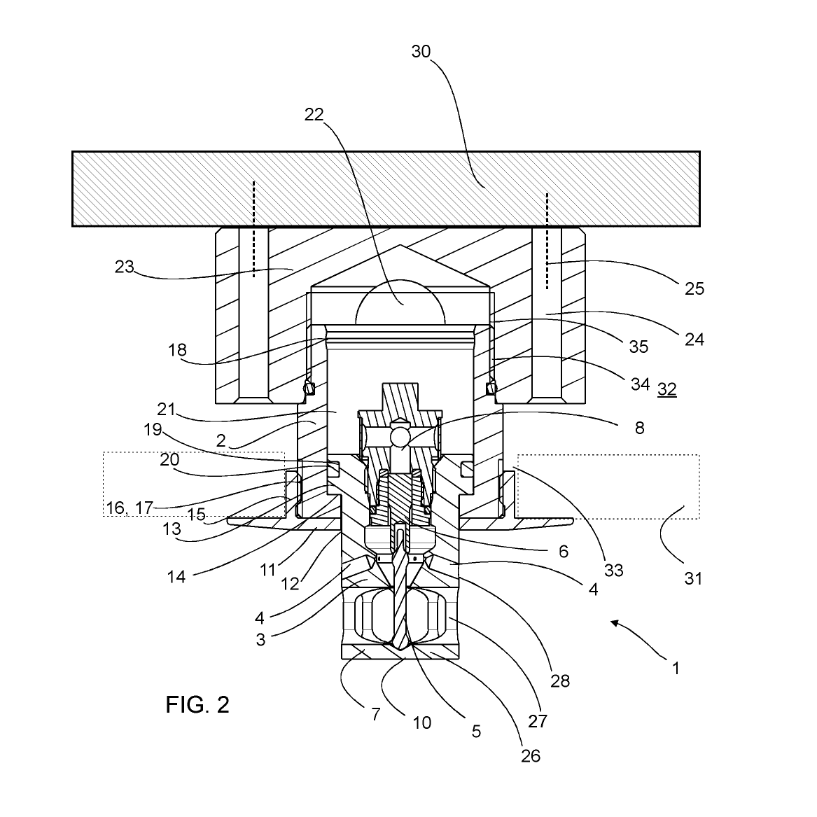

Shown in FIG. 1 is a spray head 1 according to the invention as a cross section in the first position i.e. the inactive position. In the Figure, spray head 1 has been arranged on fastening surface 30, such as a wall, ceiling or similar surface. Fastening body 2 of the spray head 1 is provided in the fastening part 23. Fastening part 23 in the embodiment of the Figure has in turn been arranged in fastening structure 30, such as ceiling, for example by means of fastening devices 25. Fastening devices 25 are depicted using dashed lines. Fastening devices 25 may for example be screw devices, that through bores 24 attach spray head 1, and possibly also pipeline 22 that is conducting the medium intended to be sprayed (shown in FIG. 2), to fastening surface 30. The wall or ceiling structure may comprise cover board 31, such as a drop ceiling, located at a distance from fastening surface 30, whereby space 32 is created for pipe 22 between fastening surface 30 and cover board 31. An opening 33 has been made in cover board 31. In the embodiment in the Figure, fastening body 2 of spray head 1 is arranged to extend to opening 32 of cover board 31 or to its vicinity. In the embodiment of the Figure, collar section 11 has been arranged into fastening body 2 or cover board 31, which from the side to be protected covers opening 32, in between fastening body 2 of spray head 1 and cover board 31. In the embodiment of the Figures, collar section 11 has been arranged by means of shoulder section 15 that extends to opening 32 of the lower part of fastening body 2. In the embodiment of the Figure, a threaded section has been formed onto shoulder part 16 of collar section 15, and a corresponding threaded section 17 has been formed onto the lower part of the fastening body. According to this embodiment, a collar section can be arranged in the spray head by twisting it into threads 16, 17. Collar section 11 may alternatively be attached in some other suitable manner, such as a crimped connection, a quick coupling or attachment devices. Collar section 11 is provided with opening 12, into which spray head section 3 of spray head 1 extends.

The body section of spray head 1, i.e. spray head body 3, has been arranged to be movable in relation to fastening body 2 at least between one first position, i.e. the inactive position, (FIG. 1) and one second position, i.e. the ready-position (FIG. 2). Spray head body section 3 is provided with at least one nozzle 4. There are several nozzles 4 in spray head 1 of the Figures. Spray head 1 has been provided with a triggering device 5, such as a thermally sensitive triggering device, for example an ampule that will break under given conditions. A triggering device 5 has been arranged between supporting body 26 in lower part 7 of spray head body 3 in FIG. 1 and valve device 6, i.e. the valve spool of the spray head, which keeps the passage of the medium closed between the spray head inlet passage 8 and nozzles 4, at least in the inactive position (FIG. 1) and in the ready-position (FIG. 2). The spray head further comprises a third state, in which spray head is activated to spray extinguishing medium, for example as a result of breakage of triggering device 5. Triggering device 5 may break for example as a result of heat from a fire or it may be made to break as a result of system actions, for example using thermal resistors or the pressure of a pressurized medium.

Fastening body 2 of spray head 1 has been provided with a cylinder space 21, in which spray head body 3 is movable between the first position and the second position. As the pressure of the medium in pipeline 22 (FIG. 2) increases, pressure is applied to the surfaces of body section 3 of the spray head, which have been formed in a way that spray head body 3 moves inside cylinder space 21 of fastening body 2 from the first position to the second position, i.e. until the corresponding surface 14 of the fastening body. Spray head body 3 has a shoulder 13, that meets the corresponding surface 14 of fastening body 2 in the second position. Shoulder 13 thereby acts as a limiting stop.

Retaining arrangement 18, 19, 20 has been arranged in spray head 1, which keeps spray head body 3 in relation to fastening body 2 in the first position, until the pressure of the medium in pipeline 22 moves spray head body 3 inside the cylinder space 21 toward the second position. The retaining arrangement in the embodiment of the Figures comprises a sealer ring 20 i.e. an O-ring, adapted to groove 19 of spray head body 2. In the first position sealer ring 20 extends until a corresponding groove 18 that has been provided on the wall of cylinder space 21 of the fastening body. As the pressure of the medium in pipeline 22 increases and attempts to move spray head body 3 in cylinder space toward second position, elastic sealer ring 20 between spray head body 3 and fastening body 2 becomes compressed and ultimately allows spray head body 3 to move toward the second position (FIG. 2). A retaining arrangement can also be formed by using bonding agent, such as glue or soldering material between the spray head body and the fastening body.

Lower surface 10 of lower part 7 of spray head 1 of spray head body 3 is in an inactive position, essentially at the level of the lower surface of fastening body 2, or as in the Figure, extending through opening 12 of collar section 11 to the level of the lower surface. The lower surface of collar section 11 and the lower surface 10 of spray head body 3 of the spray head are essentially in the same plane. According to one embodiment, the lower surface of collar section 11 and the lower surface 10 of spray head body 3 form an essentially flat and uniform surface. A uniform flat surface is easy to keep clean and will also withstand external forces well, such as attempts to cause damage. Nozzles 4 of the spray head are most advantageously located on the side surface 28 of spray head body 3 of the spray head, at which time they are in an inactive state, protected from possibly becoming dirty inside the cylinder space of the fastening body. Correspondingly, in an inactive state, triggering device 5, such as an ampule, is also protected inside the fastening body.

Spray head body 3 is movable in relation to fastening body 2 between two positions, the first position (FIG. 1), in which spray head is in an inactive state and the second position (FIG. 2), in which spray head body 3 is extended out, and said spray head body 3 is arranged to be movable by the pressurized medium in relation to fastening body 2 from the first position to the second position and at the same time to apply a force against the retaining arrangement of the spray head body, at which time the spray head body is released to move to the second position.

Fastening body 2 comprises a cylinder space 21, or channel section, whereby at least a part of spray head body 3 has been formed into a piston part, arranged to move in the cylinder space from the first position to the second position through the affect by the pressurized medium.

In one embodiment, the medium used for the moving of the spray head body section, i.e. the spray head body, is typically comprised of extinguishing medium. It is also possible to use some other suitable medium.

Spray head 1 in FIG. 2 is shown in the second position i.e. in the ready-state.

Spray head body 3 is extended out from opening 12 of fastening body 2 or fastening body and collar section 11.

Thanks to sealer ring 20, spray head body 3 stays well in place in the first position, i.e. the inactive position or protective position, at which time the important parts of the spray head are well protected from the effects of the spray head environment and external forces. Among such parts that are meant to be protected. are triggering device 5, typically an ampule, and nozzles 4. A spray head can be placed in a wide variety of environments, where it is exposed to vibration, external forces and attempts of vandalism or impurities and contamination, which may impede the operation of a conventional spray head, such as causing malfunctions of the spray head.

On the other hand, the first inactive position prevents an unwanted triggering of triggering device 5, for example as a result of spray head being exposed to an external force or a short flow of hot gas. Such situations may occur for instance in highway tunnels, where, for example, exhaust gas from a truck may briefly be pointed directly at a spray head.

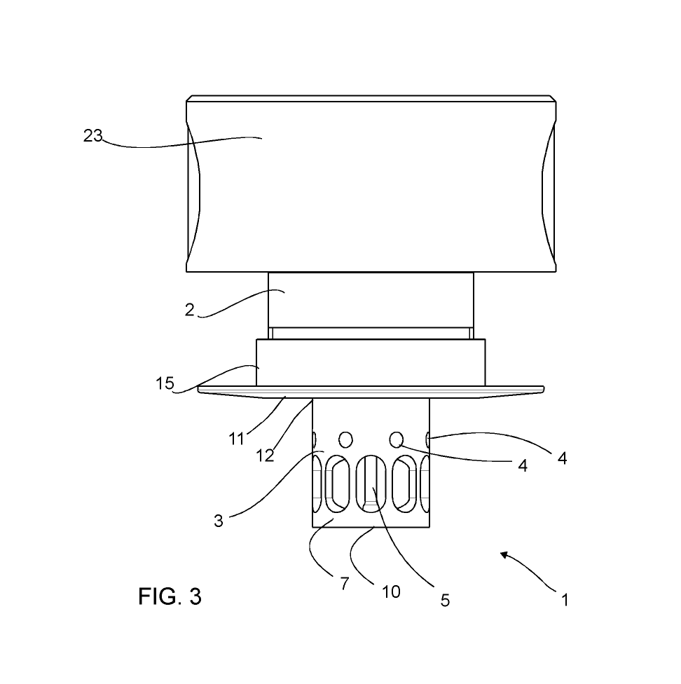

The spray head can be set in the ready-state by directing pressurized medium into pipeline 22. Thanks to this, the pressure of the medium is applied against the surfaces of the spray head, creating a force, that pushes spray head body 3 in fastening body 2 from the first position toward the second position, i.e. downward in FIG. 1. Spray head body 3 in turn affects the retaining arrangement, whereupon as the force applied to the retaining arrangement of spray head body 3 exceeds the force that keeps the spray head in place, spray head body 3 moves to a non-protective position according to FIGS. 2 and 3.

In the ready-state (FIGS. 2 and 3) the spray head can be activated in the usual manner by means of opening device 5, for example when it has been broken by heat, at which time nozzles 4 can spray extinguishing medium. In the ready-state, the spray head body 3 according to the invention, extends slightly away from the fastening body, at which time, on one hand, it is closer to a possible burning object, and at a distance from the fastening point, such as ceiling or wall surface.

Typically pipeline 22 for extinguishing medium is a so-called dry pipe, whereupon it contains no extinguishing medium. As extinguishing medium is directed into pipeline 22, extinguishing medium works in the above described manner and moves spray head body 3 from the first position to the second position and to a ready-state. Ampule 5 of the spray head in the ready-state, once broken, for example as a result of heat, begins to spray extinguishing medium out from nozzles 4 of the spray head.

Accordingly, the invention concerns a spray head 1, comprising a fastening body 2, a spray head body 3 with at least one nozzle 4 and a thermally activated triggering device 5, said spray head body 3 being arranged into fastening body 2, in its cylinder space 21, to be movable between two positions, a first position, in which spray head is in an inactive state, and a second position, in which spray head body is extended out, said spray head body 3 being arranged to be movable through the effect of pressurized medium in relation to fastening body 2 from the first position to the second position. A retaining arrangement 18, 19, 20 has been arranged between spray head body 3 and fastening body 2, adapted to keep spray head body 3 in the first position, until the pressure of the medium exceeds a preset value.

According to one embodiment, retaining arrangement 18, 19, 20 comprises a retaining element 20, or retaining arrangement has been formed using bonding agent, such as glue or soldering material. The bonding agent may be provided at a suitable location between the spray head body and the fastening body. As the pressure of the medium increases to a preset value, the spray head body is released from the joint, created with the bonding agent, and moves to the second position.

According to one embodiment, retaining arrangement 18, 19, 20 comprises at least one groove 19, that is formed onto the spray head body, and at least one groove 18 that is formed onto the fastening body, as well as at least one retaining element 20, that is arranged between the spray head body and at least one of the grooves 18, 19 of the fastening body in the first position. Thus several grooves may be formed, which allow for example the adjustment of spray head body position in relation to the fastening body in the first position. At least one retaining element is arranged at the location created by a suitable mutual position of the fastening body and of the spray head body, such as at the groove or a pair of grooves 18, 19.

According to one embodiment, retaining arrangement 18, 19, 20 comprises retaining element 20, which is an elastic element, such as a sealer ring, for example an O-ring.

According to one embodiment, in the first position i.e. the protective position, when the spray head is in the inactive state, at least one nozzle 4 of the spray head and the triggering device 5 are protected on the inside of the walls of fastening body 2, and in the second position, in which spray head body 3 is extended out, in which at least one nozzle 4 and triggering device 5 are not protected inside the walls of fastening body 2. In the second position the spray head is in the ready-state, i.e. in a pre-activated state, at which time the triggering device, such as an ampule, is exposed to hot gases. Once the triggering device has broken, the valve element is free to move to the second position, in which the path of the medium is clear to nozzles 4 and the spray head has been activated to spray extinguishing medium.

According to one embodiment, fastening body 2 comprises cylinder space 21 and at least part of spray head body 3 has been formed into a piston part, arranged to be moved by the pressure of the medium in cylinder space 21 from the first position to the second position.

According to one embodiment, spray head body 2 comprises a motion limiter device 13, such as a shoulder, and fastening body 1 comprises an corresponding surface 14 for the limiting device.

According to one embodiment, the spray head comprises collar section 11 with opening 12, through which at least part of spray head body 3 extends, at least in the second position.

According to one embodiment, lower surface 10 of spray head body 3 is arranged in the first position to extend through opening 12 essentially to the same plane with fastening body 2 or with the outer surface 10 of collar section 11, arranged in connection with fastening body 2.

According to one embodiment, collar section 11 may comprise ledge section 15, fitted into fastening body 2, on the outside thereof, for example by means of threaded sections 16, 17.

According to one embodiment, collar section 11 is an integral part of fastening body 2.

According to one embodiment, collar section 11 is an integral part of fastening part 23.

According to one embodiment, collar section 11 is an integral part of spray head body 3. Collar section 11 is then arranged to move along with spray head body 3. The collar section and the mutual position and spraying direction of the spray nozzle are arranged in such a way, that the collar section does not significantly interfere with the spray from the spray head in this embodiment.

According to one embodiment, collar section 11 and fastening body 2 are detachable from their installation object, individually or together. In the embodiments of the Figure, fastening body 2 has threads 34, from which the fastening part is arranged into corresponding threads 35 in fastening body 23.

According to one embodiment, the position of collar section 11 is adjustable in relation to fastening body 2. Collar section 11 may comprise a ledge section 15, fitted into fastening body 2, on the outside thereof, for example by means of threaded sections 16, 17. By turning collar section 15 in threads 17, its position in relation the fastening body can be adjusted.

According to one embodiment, the position of spray head body 3 in relation to fastening body 2 is adjustable in the first position.

According to one embodiment, retaining element 20 of the retaining arrangement is a ledge section, formed into spray head body 3 or fastening body 2, and in the first position is arranged to fit a corresponding part such as a groove.

According to one embodiment, the pressure medium is the extinguishing medium or a separate pressure system medium.

According to one embodiment, spray head 1 is used in a fire extinguishing system of a vehicle or a means of transportation, such as a train.

The spray head according to the invention is particularly suitable for spraying extinguishing media mist with liquid content. For applications and properties of the spray head, references can be made to publications EP 1150747 and WO01/26742 and WO 2011/001018.

It will be clear to those skilled in the art, that the invention is not limited to the embodiments presented above, but may be varied within the scope of the accompanying claims. Characteristic features possibly used together with other characteristic features in the description may also be used separately from each other, if necessary.

1. A spray head, comprising a fastening body a spray head body with at least one nozzle and a thermally activated triggering device, said spray head body being arranged into fastening body, into its cylinder space to be movable between two positions, the first position, in which spray head is in the inactive state, and the second position, in which the spray head body is extended out in a ready position prior to activation of said thermally activated triggering device, said spray head body being arranged to be movable by pressurized medium in relation to fastening body from the first position to the second position, wherein a retaining arrangement has been arranged between spray head body and fastening body, and adapted to keep the spray head body in the first position, until the pressure of the medium exceeds a preset value.

2. A spray head according to claim 1, wherein retaining arrangement comprises a retaining element, or wherein a retaining arrangement has been formed using bonding agent, such as glue or soldering material.

3. A spray head according to claim 1, wherein retaining arrangement comprises at least one groove that is formed onto the spray head body, and at least one groove that is formed onto the fastening body, as well as at least one retaining element, that is arranged between the spray head body and at least one of the grooves of the fastening body in the first position.

4. A spray head according to claim 1, wherein retaining arrangement comprises retaining element, which is an elastic element, such as a sealer ring, for example an O-ring.

5. A spray head according to claim 1, where in the first position i.e. the protective position, as the spray head is in the inactive state, at least one nozzle and triggering device of the spray head are protected on the inside of the walls of fastening body, and in the second position, in which spray head body is extended out, where at least one nozzle and triggering device are not protected inside the walls of fastening body.

6. A spray head according to claim 1, wherein fastening body comprises a cylinder space, or a channel section, whereby at least a part of spray head body has been formed into a piston part, arranged through the effect of the pressurized medium to move in the cylinder space from the first position to the second position.

7. A spray head according to claim 1, wherein spray head body comprises a motion limiter device, such as a shoulder, and fastening body comprises a corresponding surface for the limiting device.

8. A spray head according to claim 1, wherein the spray head comprises a collar section, in which there is an opening, through which at least a part of spray head body extends at least in the second position.

9. A spray head according to claim 1, wherein lower surface of spray head body is arranged in the first position to extend through opening essentially to the same plane with fastening body or with the outer surface of collar section, arranged in connection with fastening body.

10. A spray head according to claim 8, wherein collar section comprises a ledge section, fitted into fastening body, on the outside thereof, for example by means of threaded sections.

11. A spray head according to claim 8, wherein the collar section is an integral part of fastening body.

12. A spray head according to claim 8, wherein collar section is an integral part of fastening part.

13. A spray head according to claim 8, wherein collar section is an integral part of spray head body.

14. A spray head according to claim 1, wherein collar section and fastening body are detachable from their installation object, individually or together.

15. A spray head according to claim 1, wherein the position of collar section in relation to fastening body is adjustable.

16. A spray head according to claim 1, wherein the position of spray head body in relation to fastening body is adjustable at least in the first position.

17. A spray head according to claim 1, wherein retaining element of the retaining arrangement is a ledge section, formed onto the spray head body or the fastening body, which in the first position is fitted into the corresponding part, such as a groove.

18. A spray head according to claim 1, wherein the pressure medium is the extinguishing medium or a medium of a separate pressure system.

19. The use of a spray head according to claim 1 in a fire extinguishing system of a vehicle or a means of transportation, such as a train.
